(19) United States
(12) Patent Application Publication
(10) Pub. No.: US 2022/0100639 A1
(43) Pub. Date: Mar. 31, 2022

(54) COMPUTER-IMPLEMENTED METHOD AND SYSTEM FOR TEST AUTOMATION OF AN APPLICATION UNDER TEST

(71) Applicant: UiPath, Inc., New York, NY (US)

(72) Inventors: Gerd WEISHAAR, Vienna (AT); Christian MAYER, Vienna (AT); Thomas STOCKER, Gaishorn (AT)

(73) Assignee: UiPath, Inc., New York, NY (US)

(21) Appl. No.: 17/032,556

(22) Filed: Sep. 25, 2020

(51) Int. Cl. G06F 11/36; G06F 9/451

(52) U.S. Cl. CPC G06F 11/3664; G06F 11/3684; G06F 9/451; G06F 11/3692; G06F 11/3688

(57) ABSTRACT

A system and a computer-implemented method for generating a test automation file for an application under test are disclosed herein. The computer-implemented method includes obtaining an image file associated with the application under test and identifying one or more control elements in the image file. The computer-implemented method further includes generating test automation recording data for the image file using a computer vision component, by recording one or more actions performed by a user on the one or more control elements of the image file. The computer-implemented method further includes using the test automation recording data to generate the test automation file at a design stage. The computer-implemented method further includes using the test automation file for testing a live application, at a development stage. The live application can be an RPA application.

### FIELD

The present disclosure generally relates to Robotic Process Automation (RPA), and more specifically, to the test automation of user interfaces using computer vision capabilities.

### BACKGROUND

Generally, UI (User Interface) design proposals are made by UI experts and UX (User Experience) experts. Also, conventionally, test automation can be done only after software development stage. The test automation engineers may have to wait to perform test automation on UI designs for applications until the software development team completes the implementation of the UI. This is a time consuming and costly procedure. Further, debugging of the flaws in workflows at real-time in order to avoid the flaws at run-time becomes even more challenging.

Accordingly, there is a need for a tool that allows the test automation engineers to test an application for the flaws at a design stage and to decrease the wait time of the test automation engineers until the software developers implement the user interfaces.

### SUMMARY

Certain embodiments of the present invention provide solutions to the problems and needs in the art that have not yet been fully identified, appreciated, or solved by current test automation. For example, some embodiments of the present invention pertain to testing of applications at design stage, without requiring significant wait time to be spent at the developer end before beginning the testing. To that end, the various embodiments of the present inventions pertain to testing of mock images developed by UI/UX experts and use computer vision technologies for recording of user actions on mock images and using the recorded actions for generating test automations for testing of an application under test.

In an embodiment, a computer-implemented method for generating a test automation file for an application under test includes obtaining an image file associated with a user interface design of the application under test. The method also includes identifying, by a processing component, one or more control elements in the image file associated with the user interface design of the application under test. The one or more control elements includes of one or more fields accessible by the user for input of data. The method further includes generating test automation recording data using a computer vision component. The generating of the test automation recording data includes recording one or more actions performed on the one or more control elements of the obtained image file. The method also includes generating the test automation file for the application under test based on the test automation recording data. The test automation file comprises the generated test automation recording data without providing access to an actual user interface of the application under test.

In another embodiment, a non-transitory computer-readable medium stores a computer program. The computer program is configured to cause at least one processor to obtain an image file associated with a user interface design of the application under test, and identify one or more control elements in the image file associated with the user interface design of the application under test. The one or more control elements includes of one or more fields accessible by the user for input of data. The computer program is further configured to cause at least one processor to generate test automation recording data using a computer vision component. The generating of the test automation recording data includes recording one or more actions performed on the one or more control elements of the obtained image file. The computer program is further configured to cause at least one processor to generate the test automation file for the application under test based on the test automation recording data. The test automation file includes the generated test automation recording data without providing access to an actual user interface of the application under test.

In yet another embodiment, a computing system that includes memory storing machine-readable computer program instructions and at least one processor configured to execute the computer program instructions. The computer program instructions are configured to cause the at least one processor to obtain an image file associated with a user interface design of the application under test, and identify, by an artificial intelligence processing component, one or more control elements in the image file associated with the user interface design of the application under test. The computer program instructions are further configured to generate test automation recording data, using a computer vision component, by recording one or more actions performed on the one or more control elements of the image file. The generated test automation recording data includes one or more recorded actions associated with each of the one or more actions performed on the one or more control elements of the image file. The computer program instructions are further configured to generate the test automation file for the application under test based on the test automation recording data. The test automation file includes the generated test automation recording data.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a robotic process automation (RPA) system, according to an embodiment of the present invention.

FIG. 2 is an architectural diagram illustrating a deployed RPA system, according to an embodiment of the present invention.

FIG. 3 is an architectural diagram illustrating the relationship between a designer, activities, and drivers, according to an embodiment of the present invention.

FIG. 4 is an architectural diagram illustrating another RPA system, according to an embodiment of the present invention.

FIG. 5 is an architectural diagram illustrating a computing system configured for generating a test automation file for an application under test, according to an embodiment of the present invention.

FIG. 6 is an architectural diagram illustrating a user interface testing module, according to an embodiment of the present invention.

FIG. 7 is a graphical user interface (GUI) illustrating a mock image of a user interface for the application under test, according to an embodiment of the present invention.

FIGS. 8A and 8B are GUIs illustrating screenshots of scenarios to record one or more actions performed by a user on one or more control elements of the mock image to generate test automation recording data, according to an embodiment of the present invention.

FIGS. 9A and 9B are GUIs illustrating screenshots to generate test automation file for the application under test, according to with an embodiment of the present invention.

FIG. 10 is a GUI illustrating a screenshot of a live application, side-by-side, a mock image of the live application, according to with an embodiment of the present invention.

FIGS. 11A to 11D are GUIs illustrating screenshots of running recorded file of a mock image on the live application, according to an embodiment of the present invention.

FIG. 12 is a flowchart illustrating a computer-implemented method for generating a test automation file, according to an embodiment of the present invention.

FIG. 13 is a flowchart illustrating a computer-implemented method for testing a live application, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to a system (hereinafter referred to as a “computing system”) configured to generate a test automation file for an application under test using computer vision technology. The test automation file may be used for testing of a live application when the live application is available or developed. In some embodiments, the computing system is configured to generate the test automation file based on an image file, such as a mock image of a UI, associated with the application under test. Thus, the computing system enables the beginning of a testing phase of the application under test before the application under test is fully developed, that is to say, much before the application under test goes live, so as to become the live application.

Further, the computing system can truly shift left, the testing of the application under test, leading to savings in cost, time and effort spent in generating test cases for the application. Using the computing system, a user, such as a software test engineer, does not have to wait for the development of a software application, and can begin writing test cases as soon as UI/UX images for the software application are available in the design stage of a software development lifecycle

In some embodiments, the computing system enables generation of a test automation file for the application under test by use of computer vision capabilities available in the computing system. The test automation file is generated based on an image file, such as an image mockup of UI design prepared during the design stage of software development lifecycle, by recording one or more user actions performed on the image file for generation of test automation recording data. The recording is done by using the computer vision capabilities, thus providing a truly intuitive and user friendly process for capturing data for generation of test automation file. The image file is then uploaded to an AI enabled cloud server, which performs an analysis of the image file and identifies one or more control elements in the image file for recording interactions of the user in the form of one or more user actions. The AI enabled cloud server is embodied as a separate processing component, enabling the computing system to have reduced storage requirements, and have improved execution time in comparison with conventional software testing solutions available in the art. Further, the improvements in execution time and storage requirements may reduce computational overhead on the computing system. In this way, the test automation file is generated prior to beginning of actual software development lifecycle, causing a shift-left of test automation phase for an application under test, using the computing system and the computer-implemented method disclosed herein. In some embodiments, the application under test pertains to a robotic process automation (RPA) application and the computing system closely resembles or replicates an RPA system, without deviating from the scope of the present invention.

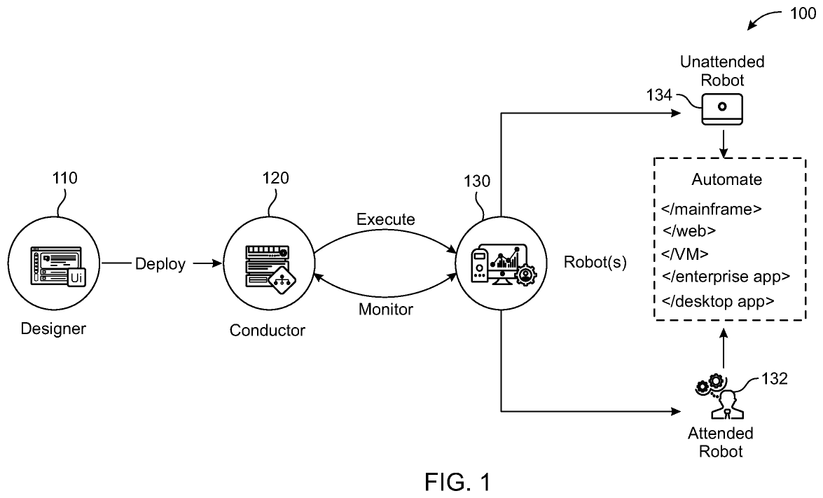

FIG. 1 is an architectural diagram illustrating an RPA system 100, according to an embodiment of the present disclosure. RPA system 100 includes a designer 110 that allows a developer or a user to design, test and implement workflows. The designer 110 provides a solution for application integration, as well as automating third-party applications, administrative Information Technology (IT) tasks, and business IT processes. The designer 110 also facilitates development of an automation project, which is a graphical representation of a business process. Simply put, the designer 110 facilitates the development and deployment of workflows and robots.

The automation project enables automation of rule-based processes by giving the developer control of the execution order and the relationship between a custom set of steps developed in a workflow, defined herein as “activities.” One commercial example of an embodiment of the designer 110 is UiPath Studio™. Each activity includes an action, such as clicking a button, reading a file, writing to a log panel, etc. In some embodiments, workflows can be nested or embedded.

Some types of workflows include, but are not limited to, sequences, flowcharts, Finite State Machines (FSMs), and/or global exception handlers. Sequences may be particularly suitable for linear processes, enabling flow from one activity to another without cluttering a workflow. Flowcharts are particularly suitable to more complex business logic, enabling integration of decisions and connection of activities in a more diverse manner through multiple branching logic operators. FSMs are be particularly suitable for large workflows. FSMs use a finite number of states in their execution, which may be triggered by a condition (i.e., transition) or an activity. Global exception handlers are particularly suitable for determining workflow behavior when encountering an execution error and for debugging processes.

Once a workflow is developed in the designer 110, execution of business processes is orchestrated by a conductor 120, which orchestrates one or more robots 130 that execute the workflows developed in the designer 110. One commercial example of an embodiment of the conductor 120 is UiPath Orchestrator™. The conductor 120 facilitates management of the creation, monitoring, and deployment of resources in an environment. The conductor 120 also acts as an integration point with third-party solutions and applications.

The conductor 120 manages a fleet of robots 130, connecting and executing the robots 130 from a centralized point. Types of robots 130 that are managed include, but are not limited to, attended robots 132, unattended robots 134, development robots (similar to the unattended robots 134, but used for development and testing purposes), and nonproduction robots (similar to the attended robots 132, but used for development and testing purposes). The attended robots 132 are triggered by user events and operate alongside a human on the same computing system. The attended robots 132 are used with the conductor 120 for a centralized process deployment and logging medium. The attended robots 132 help a human user accomplish various tasks, and may be triggered by the user events. In some embodiments, processes are not started from the conductor 120 on this type of robot and/or they do not run under a locked screen. In certain embodiments, the attended robots 132 are started from a robot tray or from a command prompt. The attended robots 132 then run under human supervision in some embodiments.

The unattended robots 134 run unattended in virtual environments and are used to automate many processes. The unattended robots 134 are responsible for remote execution, monitoring, scheduling, and providing support for work queues. Debugging for all robot types is run in the designer 110 in some embodiments. Both the attended robots 132 and the unattended robots 134 are used to automate various systems and applications including, but not limited to, mainframes, web applications, Virtual machines (VMs), enterprise applications (e.g., those produced by SAP®, SalesForce®, Oracle®, etc.), and computing system applications (e.g., desktop and laptop applications, mobile device applications, wearable computer applications, etc.).

The conductor 120 has various capabilities including, but not limited to, provisioning, deployment, configuration, queueing, monitoring, logging, and/or providing interconnectivity. Provisioning includes creating and maintenance of connections between the robots 130 and the conductor 120 (e.g., a web application). Deployment includes assuring the correct delivery of package versions to the assigned robots 130 for execution. Configuration includes maintenance and delivery of robot environments and process configurations. Queueing includes providing management of queues and queue items. Monitoring includes keeping track of robot identification data and maintaining user permissions. Logging includes storing and indexing logs to a database (e.g., an SQL database) and/or another storage mechanism (e.g., ElasticSearch®, which provides an ability to store and quickly query large datasets). The conductor 120 provides interconnectivity by acting as the centralized point of communication for the third-party solutions and/or applications.

The robots 130 are execution agents that run workflows built in the designer 110. One commercial example of some embodiments of the robot(s) 130 is UiPath Robots™. In some embodiments, the robots 130 install the Microsoft Windows® Service Control Manager (SCM)-managed service by default. As a result, the robots 130 are configured to open interactive Windows® sessions under the local system account, and have rights of a Windows® service.

In some embodiments, the robots 130 are installed in a user mode. For such robots 130, this means they have the same rights as the user under which a given robot 130 has been installed. This feature is also available for High Density (HD) robots, which ensure full utilization of each machine at its maximum potential. In some embodiments, any type of the robots 130 can be configured in an HD environment.

The robots 130 in some embodiments are split into several components, each being dedicated to a particular automation task. The robot components in some embodiments include, but are not limited to, SCM-managed robot services, user mode robot services, executors, agents, and command line. SCM-managed robot services manage and monitor Windows® sessions and act as a proxy between the conductor 120 and the execution hosts (i.e., the computing systems on which robots 130 are executed). These services are trusted with and manage the credentials for the robots 130. A console application is launched by the SCM under the local system.

User mode robot services in some embodiments manage and monitor Windows® sessions and act as a proxy between the conductor 120 and the execution hosts. The user mode robot services can be trusted with and manage the credentials for the robots 130. A Windows® application is automatically launched if the SCM-managed robot service is not installed.

Executors run given jobs under a Windows® session (i.e., they may execute workflows). The executors are aware of per-monitor dots per inch (DPI) settings. Agents can be Windows® Presentation Foundation (WPF) applications that display the available jobs in the system tray window. The agents may be a client of the service. The agents are configured to request to start or stop jobs and change settings. The command line is a client of the service. The command line is a console application that requests to start jobs and waits for their output.

Having components of the robots 130 split as explained above helps developers, support users, and computing systems more easily run, identify, and track what each component is executing. Special behaviors can be configured per component this way, such as setting up different firewall rules for the executor and the service. The executor are always aware of the DPI settings per monitor in some embodiments. As a result, the workflows are executed at any DPI, regardless of the configuration of the computing system on which they were created. Projects from the designer 110 are also independent of a browser zoom level in some embodiments. For applications that are DPI-unaware or intentionally marked as unaware, DPI is disabled in some embodiments.

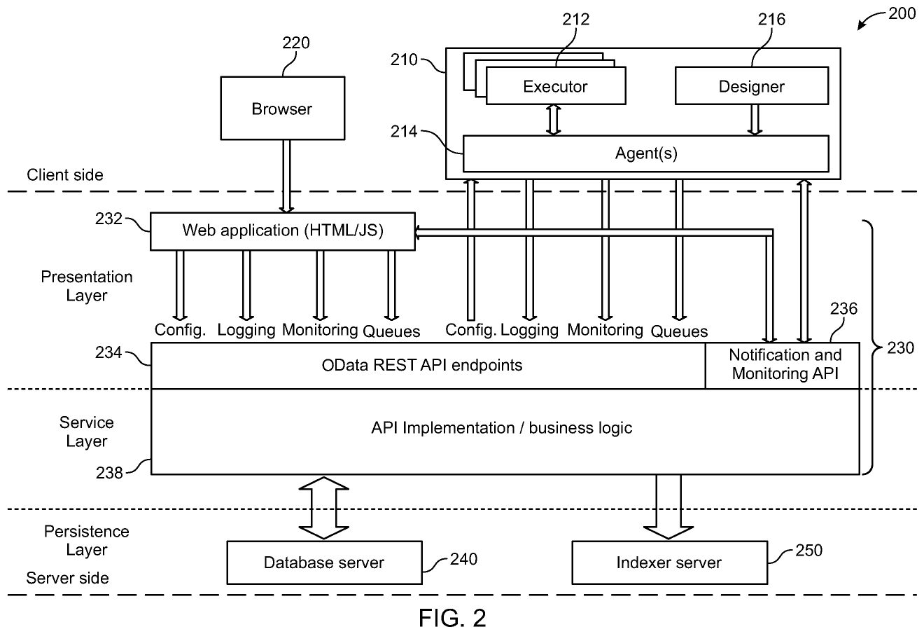

FIG. 2 is an architectural diagram illustrating a deployed RPA system 200, according to an embodiment of the present disclosure. In some embodiments, the RPA system 200 may be, or may not be a part of, the RPA system 100 of FIG. 1. It should be noted that a client side, a server side, or both, include any desired number of the computing systems without deviating from the scope of the invention. On the client side, a robot application 210 includes executors 212, an agent 214, and a designer 216 (for instance, the designer 110). However, in some embodiments, the designer 216 is not running on the robot application 210. The executors 212 are running processes. Several business projects (i.e., the executors 212) run simultaneously, as shown in FIG. 2. The agent 214 (e.g., the Windows® service) is the single point of contact for all the executors 212 in this embodiment. All messages in this embodiment are logged into a conductor 230, which processes them further via a database server 240, an indexer server 250, or both. As discussed above with respect to FIG. 1, the executors 212 are robot components.

In some embodiments, a robot represents an association between a machine name and a username. The robot manages multiple executors at the same time. On computing systems that support multiple interactive sessions running simultaneously (e.g., Windows® Server 2012), there multiple robots are running at the same time, each in a separate Windows® session using a unique username. This is referred to as HD robots above.

The agent 214 is also responsible for sending the status of the robot (e.g., periodically sending a “heartbeat” message indicating that the robot is still functioning) and downloading the required version of the package to be executed. The communication between the agent 214 and the conductor 230 is always initiated by the agent 214 in some embodiments. In the notification scenario, the agent 214 opens a WebSocket channel that is later used by the conductor 230 to send commands to the robot (e.g., start, stop, etc.).

On the server side, a presentation layer (a web application 232, an Open Data Protocol (OData) Representative State Transfer (REST) Application Programming Interface (API) endpoints 234, and a notification and monitoring API 236), a service layer (an API implementation/business logic 238), and a persistence layer (the database server 240 and the indexer server 250) are included. The conductor 230 includes the web application 232, the OData REST API endpoints 234, the notification and monitoring API 236, and the API implementation/business logic 238. In some embodiments, most actions that a user performs in an interface of the conductor 220 (e.g., via a browser 220) are performed by calling various APIs. Such actions include, but are not limited to, starting jobs on robots, adding/removing data in queues, scheduling jobs to run unattended, etc. without deviating from the scope of the invention. The web application 232 is the visual layer of the server platform. In this embodiment, the web application 232 uses Hypertext Markup Language (HTML) and JavaScript (JS). However, any desired markup languages, script languages, or any other formats can be used without deviating from the scope of the invention. The user interacts with web pages from the web application 232 via the browser 220 in this embodiment in order to perform various actions to control the conductor 230. For instance, the user creates robot groups, assign packages to the robots, analyze logs per robot and/or per process, start and stop robots, etc.

In addition to the web application 232, the conductor 230 also includes service layer that exposes the OData REST API endpoints 234. However, other endpoints are also included without deviating from the scope of the invention. The REST API is consumed by both the web application 232 and the agent 214. The agent 214 is the supervisor of the one or more robots on the client computer in this embodiment.

The REST API in this embodiment covers configuration, logging, monitoring, and queueing functionality. The configuration endpoints are used to define and configure application users, permissions, robots, assets, releases, and environments in some embodiments. Logging REST endpoints are used to log different information, such as errors, explicit messages sent by the robots, and other environment-specific information, for instance. Deployment REST endpoints are used by the robots to query the package version that should be executed if the start job command is used in conductor 230. Queueing REST endpoints are responsible for queues and queue item management, such as adding data to a queue, obtaining a transaction from the queue, setting the status of a transaction, etc.

Monitoring REST endpoints monitor the web application 232 and the agent 214. The notification and monitoring API 236 are configured as REST endpoints that are used for registering the agent 214, delivering configuration settings to the agent 214, and for sending/receiving notifications from the server and the agent 214. The notification and monitoring API 236 also uses WebSocket communication in some embodiments.

The persistence layer includes a pair of servers in this embodiment—the database server 240 (e.g., a SQL server) and the indexer server 250. The database server 240 in this embodiment stores the configurations of the robots, robot groups, associated processes, users, roles, schedules, etc. This information is managed through the web application 232 in some embodiments. The database server 240 also manages queues and queue items. In some embodiments, the database server 240 stores messages logged by the robots (in addition to or in lieu of the indexer server 250).

The indexer server 250, which is optional in some embodiments, stores and indexes the information logged by the robots. In certain embodiments, the indexer server 250 can be disabled through the configuration settings. In some embodiments, the indexer server 250 uses ElasticSearch®, which is an open source project full-text search engine. The messages logged by robots (e.g., using activities like log message or write line) are sent through the logging REST endpoint(s) to the indexer server 250, where they are indexed for future utilization.

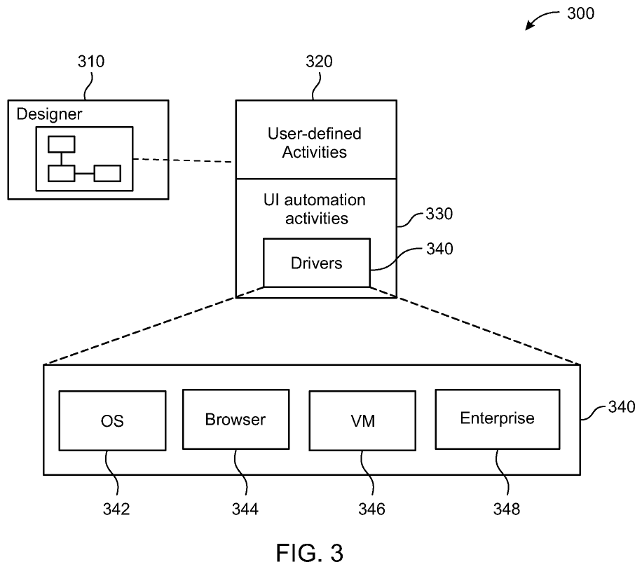

FIG. 3 is an architectural diagram illustrating a relationship 300 between a designer 310, user-defined activities 320, User Interface (UI) automation activities 330, and drivers 340, according to an embodiment of the present disclosure. Per the above, a developer uses the designer 310 to develop workflows that are executed by robots. According to some embodiments, the designer 310 can be a design module of an integrated development environment (IDE), which allows the user or the developer to perform one or more functionalities related to the workflows. The functionalities include editing, coding, debugging, browsing, saving, modifying and the like for the workflows. In some example embodiments, the designer 310 facilitates in analyzing the workflows. Further, in some embodiments, the designer 310 is configured to compare two or more workflows, such as in a multi-window user interface. The workflows include user-defined activities 320 and UI automation activities 330. Some embodiments are able to identify non-textual visual components in an image, which is called computer vision (CV) herein. Some CV activities pertaining to such components include, but are not limited to, click, type, get text, hover, element exists, refresh scope, highlight, etc. The click in some embodiments identifies an element using CV, optical character recognition (OCR), fuzzy text matching, and multi-anchor, for example, and clicks it. The type identifies an element using the above and types in the element. The get text identifies the location of specific text and scan it using the OCR. The hover identifies an element and hover over it. The element exists checks whether an element exists on the screen using the techniques described above. In some embodiments, there can be hundreds or even thousands of activities that are implemented in the designer 310. However, any number and/or type of activities can be available without deviating from the scope of the invention.

The UI automation activities 330 are a subset of special, lower level activities that are written in lower level code (e.g., CV activities) and facilitate interactions with the screen. In some embodiments, the UI automation activities 330 include activities, which are related to debugging flaws or correcting flaws in the workflows. The UI automation activities 330 facilitate these interactions via the drivers 340 that allow the robot to interact with the desired software. For instance, the drivers 340 include Operating System (OS) drivers 342, browser drivers 344, VM drivers 346, enterprise application drivers 348, etc.

The drivers 340 interact with the OS drivers 342 at a low level looking for hooks, monitoring for keys, etc. They facilitate integration with Chrome®, IE®, Citrix®, SAP®, etc. For instance, the “click” activity performs the same role in these different applications via the drivers 340. The drivers 340 enable execution of an RPA application in an RPA system.

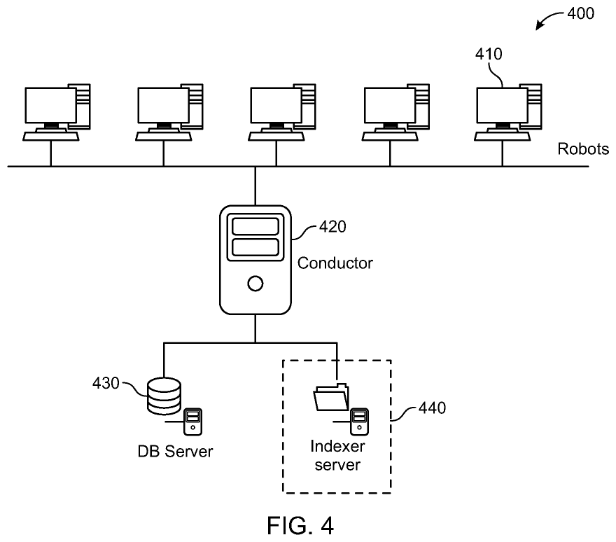

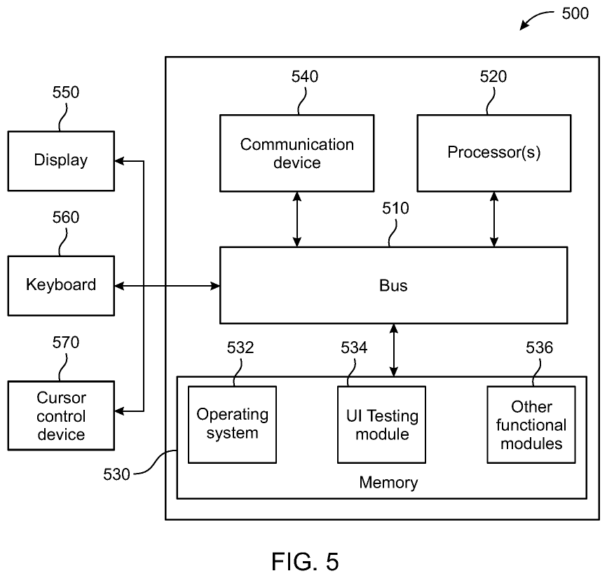

FIG. 4 is an architectural diagram illustrating an RPA system 400, according to an embodiment of the present disclosure. In some embodiments, the RPA system 400 may be or include the RPA systems 100 and/or 200 of FIGS. 1 and/or 2. The RPA system 400 includes multiple client computing systems 410 (for instance, running robots). The computing systems 410 communicate with a conductor computing system 420 via a web application running thereon. The conductor computing system 420, in turn, communicates with a database server 430 (for instance, the database server 240) and an optional indexer server 440 (for instance, the optional indexer server 250).

With respect to the FIGS. 1 and 3, it should be noted that while the web application is used in these embodiments, any suitable client/server software can be used without deviating from the scope of the invention. For instance, the conductor is configured to run a server-side application that communicates with non-web-based client software applications on the client computing systems.

FIG. 5 is an architectural diagram illustrating a computing system 500 configured for a robotic process automation (RPA) workflow of user interfaces in an application under test, according to an embodiment of the present disclosure. In some embodiments, the computing system 500 is one or more of the computing systems depicted and/or described herein. The computing system 500 includes a bus 510 or other communication mechanism for communicating information, and processor(s) 520 coupled to the bus 510 for processing information. The processor(s) 520 can be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. The processor(s) 520 also have multiple processing cores, and at least some of the cores may be configured to perform specific functions. Multi-parallel processing may be used in some embodiments. In certain embodiments, at least one of the processor(s) 520 is a neuromorphic circuit that includes processing elements that mimic biological neurons. In some embodiments, neuromorphic circuits do not require the typical components of a Von Neumann computing architecture.

The computing system 500 further includes a memory 530 for storing information and instructions to be executed by the processor(s) 520. The memory 530 may be comprised of any combination of Random Access Memory (RAM), Read Only Memory (ROM), flash memory, cache, static storage such as a magnetic or optical disk, or any other types of non-transitory computer-readable media or combinations thereof. The non-transitory computer-readable media may be any available media that is accessed by the processor(s) 520 and may include volatile media, non-volatile media, or both. The media may also be removable, non-removable, or both.

Additionally, the computing system 500 includes a communication device 540, such as a transceiver, to provide access to a communications network via a wireless and/or wired connection. In some embodiments, the communication device 540 is configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, the communication device 540 includes one or more antennas that are singular, arrayed, phased, switched, beamforming, beamsteering, a combination thereof, and or any other antenna configuration without deviating from the scope of the invention.

The processor(s) 520 are further coupled via the bus 510 to a display 550, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. The display 550 can be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O can be used without deviating from the scope of the invention.

A keyboard 560 and a cursor control device 570, such as a computer mouse, a touchpad, etc., are further coupled to the bus 510 to enable a user to interface with computing system. However, in certain embodiments, a physical keyboard and mouse are not present, and the user interacts with the device solely through the display 550 and/or a touchpad (not shown). Any type and combination of input devices can be used as a matter of design choice. In certain embodiments, no physical input device and/or display is present. For instance, the user interacts with the computing system 500 remotely via another computing system in communication therewith, or the computing system 500 may operate autonomously.

The memory 530 stores software modules that provide functionality when executed by the processor(s) 520. The modules include an operating system 532 for the computing system 500. The modules further include a UI testing module 534 that is configured to perform all or part of the processes described herein or derivatives thereof. The computing system 500 includes one or more additional functional modules 536 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present disclosure in any way but is intended to provide one example of the many embodiments of the present disclosure. Indeed, methods, systems, and apparatuses disclosed herein can be implemented in localized and distributed forms consistent with computing technology, including cloud computing systems.

It should be noted that some of the system features described in this specification have been presented as modules, in order to more particularly emphasize their implementation independence. For example, a module can be implemented as a hardware circuit comprising custom very large scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices, graphics processing units, or the like.

A module is also at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but include disparate instructions stored in different locations that, when joined logically together, comprise the module and achieve the stated purpose for the module. Further, modules are stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and could even be distributed over several different code segments, among different programs, and across several memory devices. Similarly, operational data is identified and illustrated herein within modules, and can be embodied in any suitable form and organized within any suitable type of data structure. The operational data is collected as a single data set, or can be distributed over different locations including over different storage devices, and exists, at least partially, merely as electronic signals on a system or network.

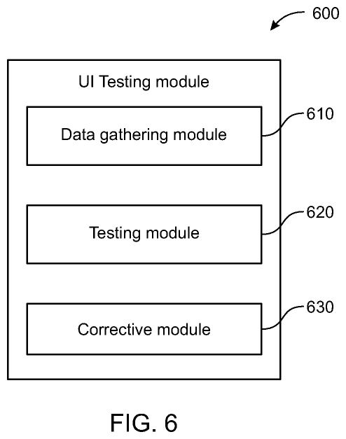

FIG. 6 is an architectural diagram illustrating a UI testing module 600, according to an embodiment of the present disclosure. In some embodiments, the UI testing module 600 is similar to, or the same as, UI testing module 534 illustrated in FIG. 5. Also, in some embodiments, UI testing module 600 is embodied within designer 110. UI testing module 600 includes a data gathering module 610, a testing module 620, and a corrective module 630, which are executed by processor(s) 520 to perform their specific functionalities to test the RPA workflow for user interfaces in an application under test.

Data gathering module 610 obtains the RPA workflow from the user. Depending on the embodiment, data gathering module 610 obtains the RPA workflow as a data file or as a recorded file, such as a test automation file, where the one or more actions of the user are recorded. The test automation file includes, but is not limited to, a Solution Design Document (SDD), a Process Design Instruction (PDI), an Object Design Instruction (ODI), or business process (BP) code.

In certain embodiments, data gathering module 610 provides an enable-option to the user who may be testing user interfaces for an application, which is at a design stage. For example, when the user enables the enable-option, data gathering module 610 obtains one or more activities (i.e., a sequence) of the RPA workflow (for instance, live-data from the user). Data gathering module 610 may trigger a desktop recorder that obtains the live-data from the user. For example, the desktop recorder records the user's keyboard actions (e.g., mouse clicks and x & y coordinates; keyboard presses; desktop screen object detection (e.g., identify buttons and text fields selected by the user)) as well as identifies the application currently being accessed and receiving the user's keyboard actions. The desktop recorder may also measure a length of time elapsed for the workflow, measure a length of time elapsed for each activity in the workflow, count a number of steps in the workflow, and provide a graphical user interface for controlling the recording stop, start, and pause functions. Further, the RPA workflow or the sequence of the RPA workflow, obtained by data gathering module 610, are used by UI testing module 620.

In another example, the UI testing module 600 comprises the RPA workflow and the predicted flaw information associated with the RPA workflow.

According to some embodiments, UI testing module 620 analyzes the recorded file to output the tested recorded file. For instance, the UI testing module 620 analyzes each RPA workflow in the recorded file to output their corresponding tested RPA workflows.

According to some embodiments, UI testing module 600 further includes one or more additional modules, e.g., a corrective module. The corrective module performs one or more corrective activities. The corrective activities include providing feedback to the user regarding better possibility of the RPA workflow or the activity of the RPA workflow, generating a report about metrics associated with the RPA workflow, generating the mock image with flaws.

In some embodiments, the corrective module provides feedback to the user regarding better possibility of the RPA workflow. According to some example embodiments, the feedback includes a modified RPA workflow or a suggestion message to modify the RPA workflow. The suggestion message may include information for modifying the RPA workflow. The modified RPA workflow has better metrics in comparison to the metric associated with the RPA workflow.

According to some embodiments, the feedback is provided by a machine learning (ML) model (not shown in the FIG.) where the ML model is trained using best practice documents and frameworks (for instance, Robotic Enterprise framework) to build a high quality RPA workflow. In some embodiments, the generated report about the metrics is indicated in percentage.

In certain embodiments, corrective module 630 generates the warning message or the error message associated with the RPA workflow. The warning message or the error message includes a summary comprising the rules violation details or the flaws information for an activity of the RPA workflow, when the activity violates the set of rules or the activity contains flaws. According to some embodiments, the corrective module generates tooltip icon comprising the warning message or the error message associated with the RPA workflow. The corrective module may also output an activity name and its corresponding number such that the user accesses the activity for modifying the activity, when the activity violates the set of rules or the activity contains flaws. The corrective module may also include the functionalities of the workflow comparison module. For example, the corrective module generates a comparison report on the RPA workflow and the modified RPA workflow. The comparison report may include the RPA workflow and the modified RPA workflow (for instance, side by side) with changes highlighted in different colors. In some embodiments, the changes include one or more of newly added lines, deleted lines, or modified lines.

It should also be understood, once the corrective activities are performed for the RPA workflow, and if the metrics associated with the RPA workflow is compatible with threshold metrics, the RPA workflow can be outputted as a package. Further, the package is deployed by conductor 120. In some embodiments, the threshold metrics could be pre-defined by the user and provide a limit or range limitation on the values possible for a metric. The threshold are defined in terms of percentages.

In certain embodiments, designer 110 provides an option to re-run the fore-described testing on the RPA workflow, if the metrics associated with the RPA workflow is not compatible with threshold metrics.

In this way, UI testing module 600 performs the foresaid operations, when executed by processor(s) 520, to debug the RPA workflow or the activity of the RPA workflow prior to the deployment. This results in designing an accurate RPA workflow, at design stage. The accurate RPA workflow comprises least possible instructions to execute the user-defined process (i.e., the RPA workflow with less storage requirement and less execution time). For instance, UI testing analyzer 600 identifies the flaws (also includes activities that fail the set of rules validation) associated with the RPA workflow and modify the RPA workflow to remove the flaws for designing the accurate RPA workflow. Also, in some embodiments, workflow analyzer 600 removes the flaws by interleaving technique (e.g., an interleaving code development). Further, the accurate RPA workflow has improved metrics in comparison to the RPA workflow, for instance, improvement in the reliability value, the reusability value, the accuracy value, and the like. In some further embodiments, workflow analyzer 600 integrates with various Cl/CD (Continuous Integration and Continuous Deliver) tools and other applications and services for providing timing analysis.

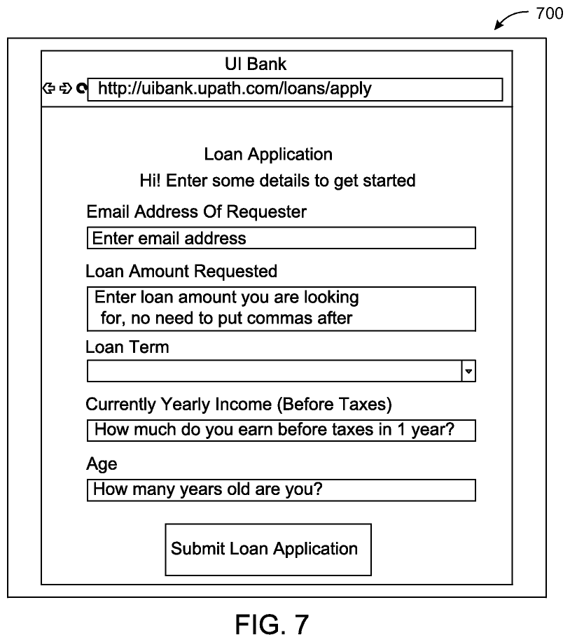

FIG. 7 is a GUI illustrating a mock image 700 of user interface for a workflow, according to an embodiment of the present disclosure.

In this embodiment, mock image 700 indicates a banking application mock image of user interface. Mock image 700 corresponds to an image file that is used for generating a test automation for an application under test in some embodiments. Mock image 700 is provided by UI and UX experts for test automation of user interfaces in workflow. In an embodiment, the mock image could be a PNG file. For example, mock image 700 is the image file of a user interface of a banking application that allows a user to apply for a loan by entering “Email Address”, “Loan Amount”, “Loan Tenure”, “Yearly Income” and “Age”. The banking application is submitted to a loan application to create loan quotes in the bank. The Workflow comprises input (i.e., the RPA workflow from the user) to computing system 500. Computing system 500 executes UI testing module 534 to debug the workflow.

Based on a mockup image, such as mock image 700, for the banking application, test automation engineers may start UI test automation efforts by creating recorded files on such mock images that are provided by UI/UX experts. Thus, using testing module 534, the users, such as developers, are able to shift left the testing process of an RPA application, by starting testing of user interfaces associated with the RPA application much before actual coding and development of those user interfaces. In a way, the testing of the user interfaces begins in the design stage itself by using the test automation capabilities provided by the UI testing module 534. Further, the use of computer vision (CV) technology to generate these test cases makes the UI test automation process more intuitive, convenient, quick, and effective for an end user, which could be a developer or even a designer of UI/UX modules.

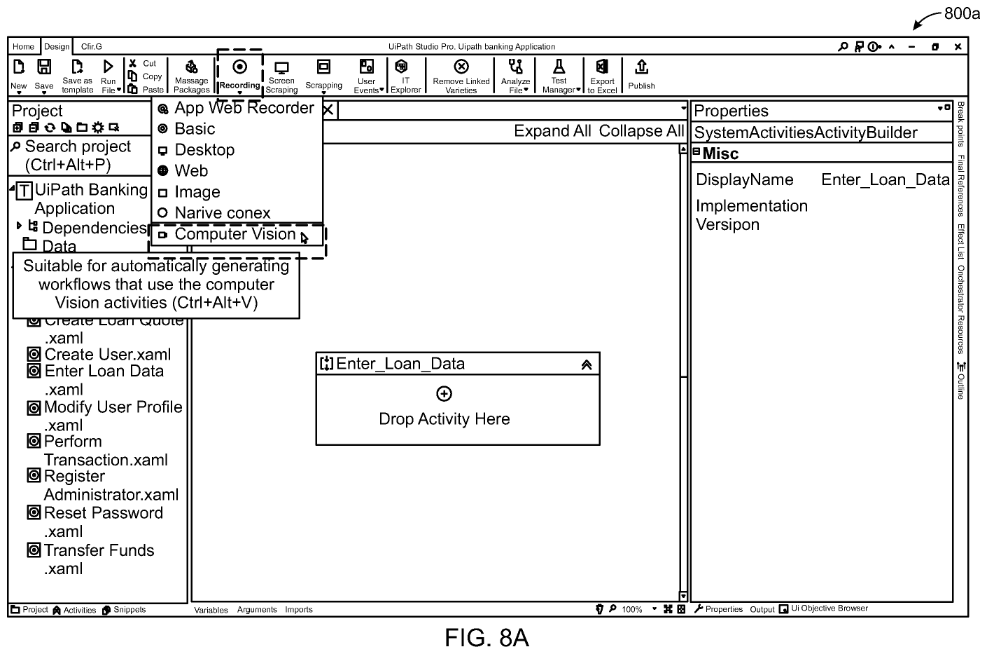

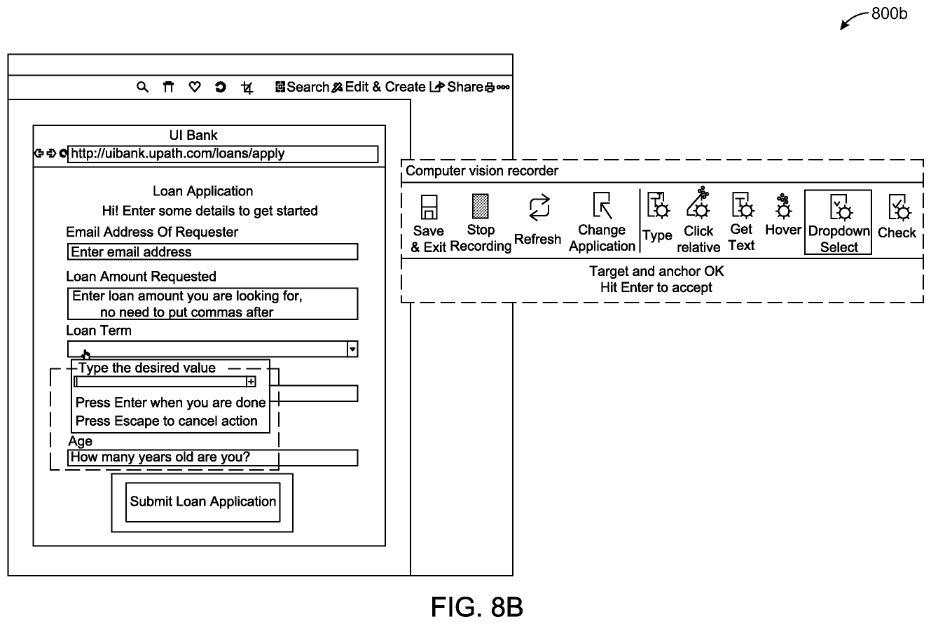

FIGS. 8A and 8B are GUIs illustrating an exemplary scenario to record one or more actions associated with a user on one or more control elements of the mock image to create a recorded file, according to an embodiment of the present disclosure.

In some embodiments, designer 110 is opened by the user to create a new test case for filling the loan data in the application as shown in mock image 700 of FIG. 7. In order to create a recorded file for automation based on the mock image, the user clicks on “Ribbon” named “Recording” and uses computer vision based recorder in the designer 110.

However, before proceeding with the recording, the user may select an image of the mockup as the mock image and upload the same to a cloud AI server or on premise server in order to identify all the UI controls that can be identified on the mock image. The user may interact with all the controls in the mock image. The recorder is configured to record actions performed on the mock image by the user. The one or more actions correspond to filling of the fields on the mock image by the user. In an embodiment, the one or more actions include filling the data (or mock data) in the loan application form.

With reference to FIG. 8B, the box with rounded dots shows a recorder recording the user actions on the mock image and the box with dashed lines shows space where the user fills the details in the form of banking application.

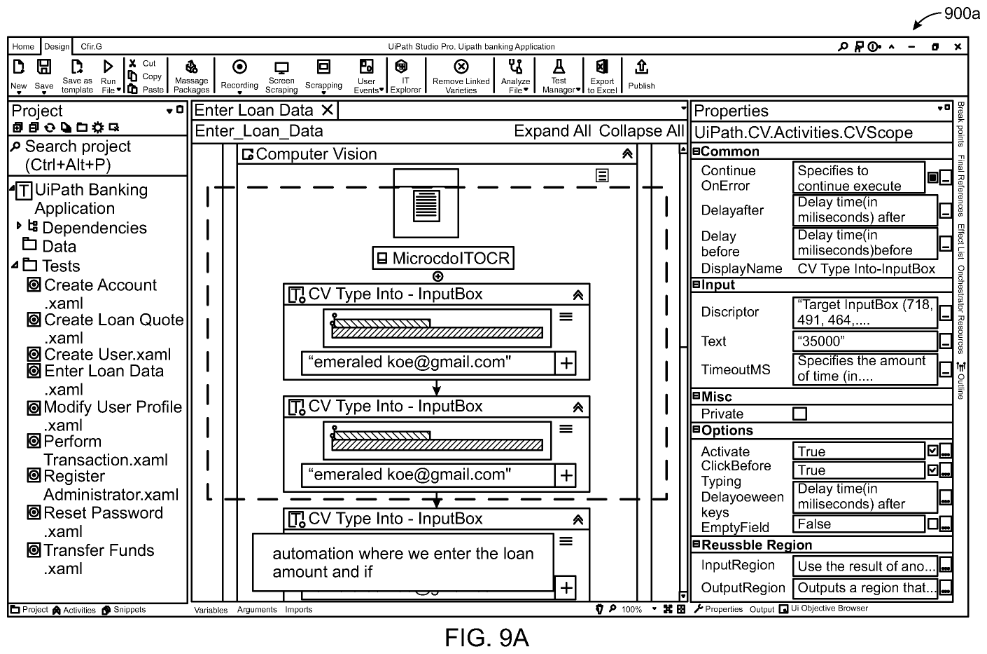

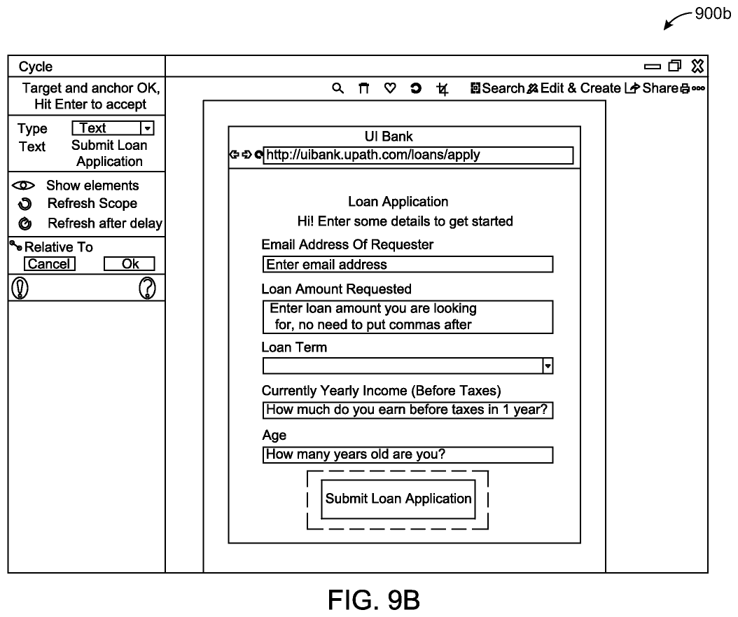

FIGS. 9A and 9B are GUIs illustrating screenshots to create recorded files as workflows based on computer vision recorder, according to an embodiment of the present disclosure.

With reference to FIG. 9A, the recorded automations are shown in designer 110 in sequential form as a workflow in 900A when the mock data in the form of banking application is filled and the user had stopped the recording after filling the mock data. This is one of the ways for creating recorded file based on the computer vision recorder.

With reference to FIG. 9B, the recorded automations are shown in designer 110 where the user adds the computer vision activities in the workflow and indicate the scope by selecting a button on an image that is uniquely identifiable as shown in 900B.

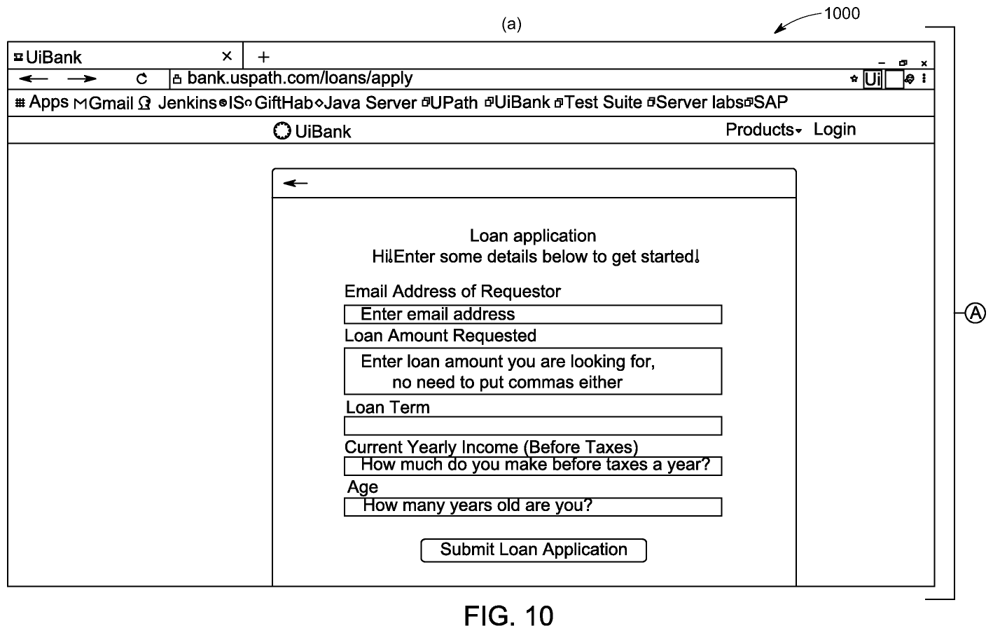

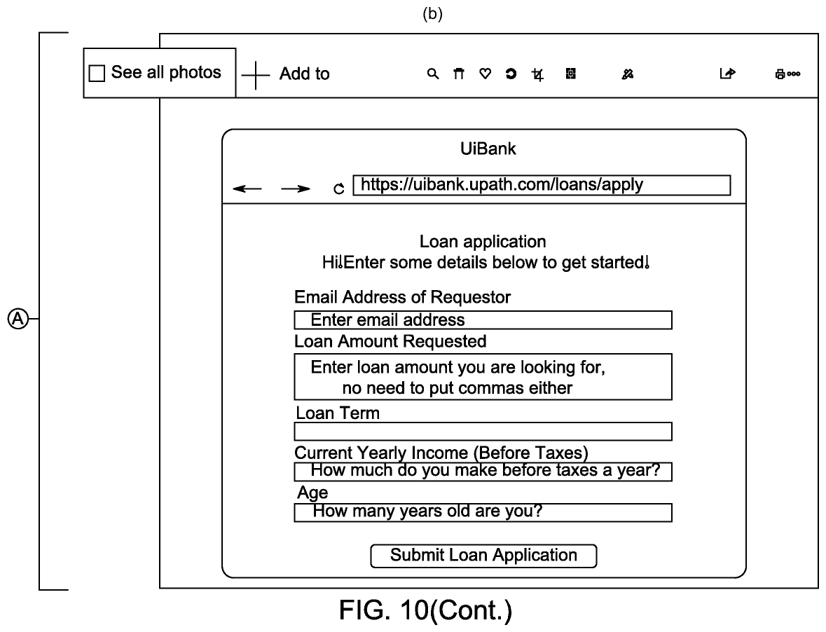

FIG. 10 is a graphical user interface 1000 illustrating a mock web application or image (a) to run automation on a mock image (b), according to an embodiment of the present disclosure. With testing, a Test Case typically cannot be created based on a drawing, requiring a user to wait until the actual implementation has been completed by the developer. In some embodiments, such as that shown in FIG. 10, Test Cases are created at the beginning (i.e., prior to development) using only the drawing as a template. See image (a) of FIG. 10. For example, a computer vision algorithm may identify the drawn control elements (e.g., buttons or text boxes) visually. To do so, a near-by label approach is used as identification, in some embodiments. This way, the automation (see image (b) of FIG. 10) created based on this drawing may also be executable on the actual application. As shown in FIG. 10, image (b) looks similar to the image (a) in terms of content and field.

As described for FIGS. 9A and 9B, where a set of automations are created based on the mock image, the user is still unable to run automation on the mock image. Therefore, with reference to FIG. 10, a web application is created to run automation on mock image (b), based on the user interface of the application under test or in design stage. Such web application works similarly as mock image (b). The web application is shown on the left side and the mock image is shown on the right side of the FIG. 10. In an embodiment, the web application and the mock image are provided by UI and UX designers.

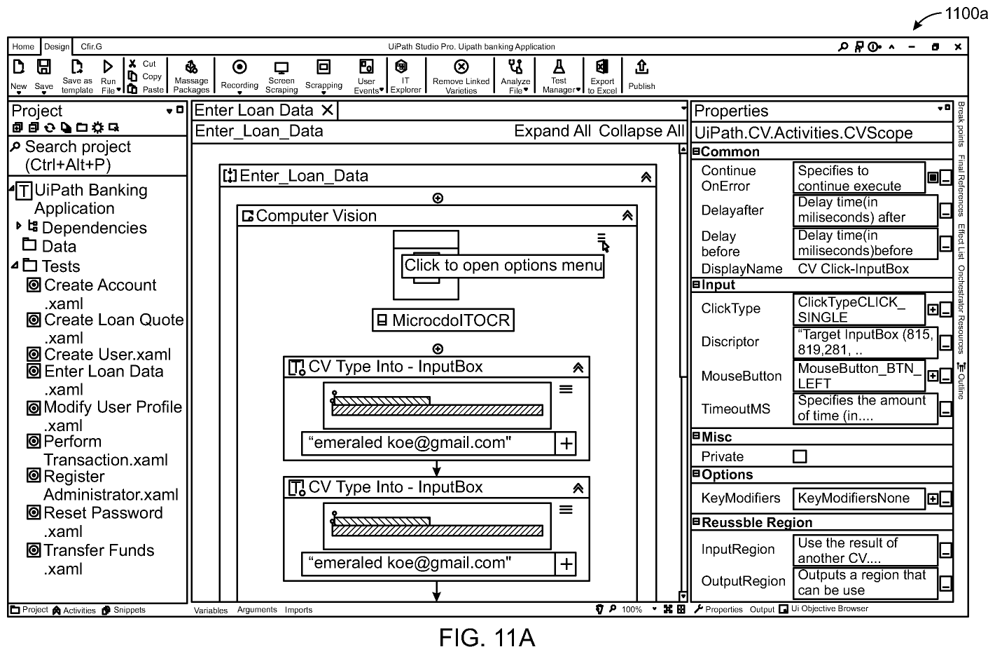

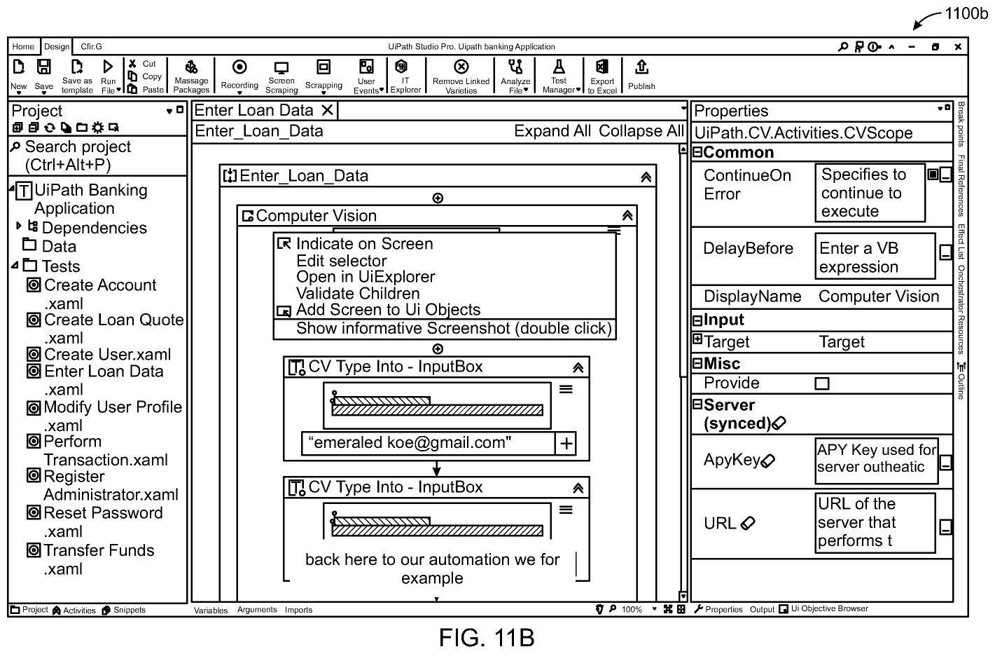

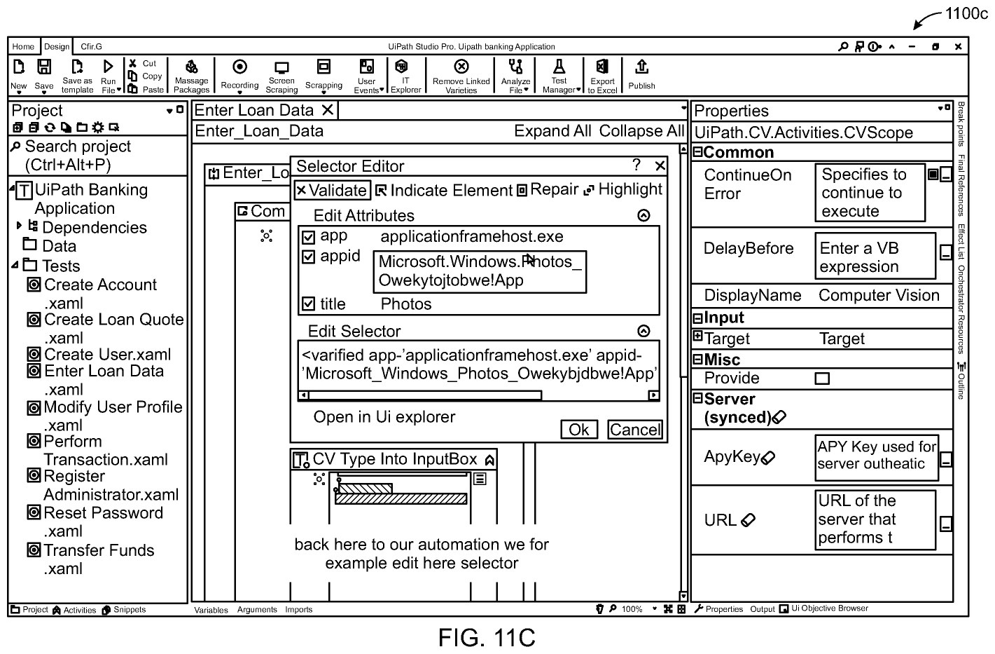

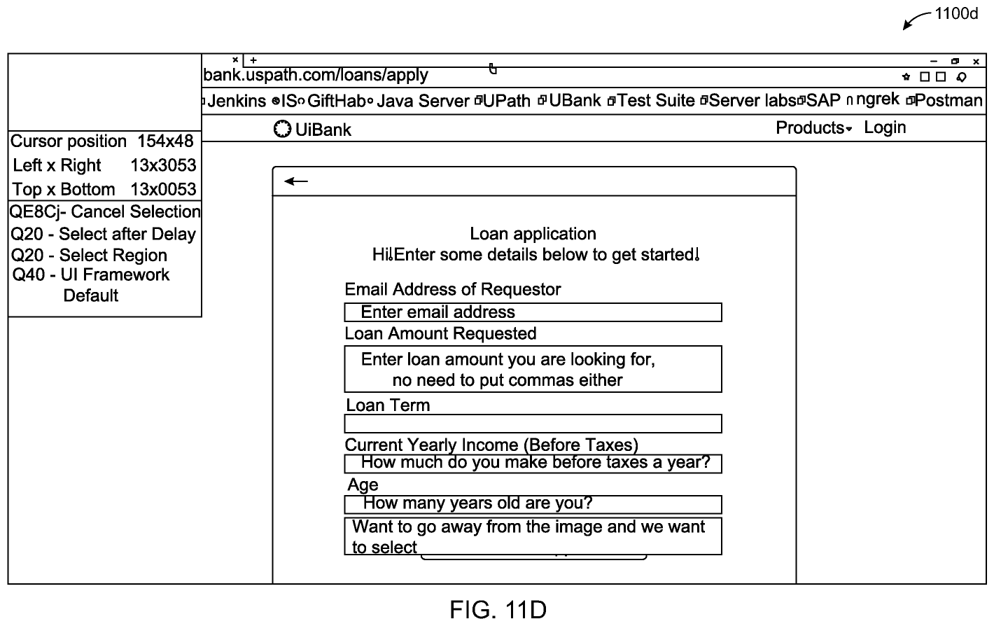

FIG. 11A to 11D are GUIs 1100A-D illustrating screenshots of running recorded file of a mock image on a web application in accordance with an embodiment of the present disclosure.

With reference to FIG. 11A, to run the recorded file for one or more recorded actions of a user on the web application for mock image, the user uses a designer 110. The user clicks on the options button on created automation. Further as shown in FIG. 11B, the user clicks on “Edit the selector”. Furthermore, with reference to FIGS. 11C and 11D, a target is chosen by the user on which automation has to be performed. The target corresponds to, but not limited to, Chrome. In an embodiment, in designer 110, the run file is clicked to execute the recorded file on the web application. When clicked on the run file, designer 110 communicates with cloud AI server to analyze application and then perform automation. Therefore, the computer vision shift left the test automation efforts by enabling the user to start automating user interfaces without really having access to the actual user interface.

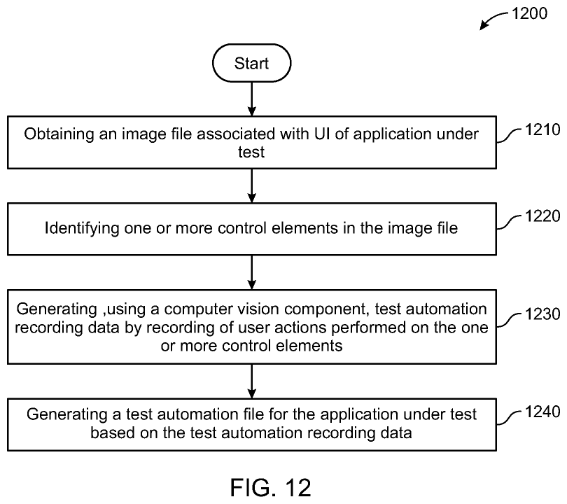

FIG. 12 is a flowchart illustrating a computer-implemented method 1200 for generating a test automation file, according to an embodiment of the present invention.

The computer-implemented method 1200 begins execution at Start control box when a trigger for executing the method 1200 is received.

The computer-implemented method 1200 includes, at 1210, obtaining the image file associated with a UI design of the application under test. The image file corresponds to a mockup of the UI design of an actual application, such as a deployed RPA application or the application under test, which is yet to be developed. In some embodiments, the image file is a Portable Network Graphic (PNG) format file. In other embodiments, the image file could be any of the available lossy or lossless image file formats known in the art, including but not limited to: a Joint Photographic Experts Group (JPEG) format image, a JPG format image, a Tagged Image File Format (TIFF) format image, a bitmap (BMP) format image, a Graphics Interchange Format (GIF) format image, an Encapsulated PostScript (EPS) format image, and a RAW type image.

Once the image file is obtained, the computer-implemented method 1200 includes, at 1220, identifying one or more control elements in the image file. The one or more control elements of the image file are the elements which a user may use for interacting with the UI that is illustrated by the design image file. For example, the one or more control elements correspond to fields for filling mock data in the image file. Such fields include, but are not limited to, a text box, a button, a drop-down list, a window, a checkbox, a navigation component such as a slider, a form, a radio button, a menu, an icon, a tooltip, a search field, a sidebar, a loader, a toggle button and the like.

In some embodiment, the one or more control elements are identified by finding the position of the one or more control elements (e.g., button or text box) on the drawing. Because a drawing is analyzed, the image on the drawings itself cannot be used by the user. However, with the AI processing component, the relative position of the one or more control elements are identified. The relative position is identified using, for example, a coordinate system.

In some embodiments, the image file is uploaded to an AI processing component, such as an AI-enabled cloud sever, where the image file is analyzed using AI techniques to identify the one or more control elements associated with the image file. In some embodiments, the AI processing component is embodied to be a part of the computing system executing the method 1200 so that the image file is analyzed locally on the computing system using the AI processing component to identify the one or more control elements. For instance, the AI processing component identifies the type of control (e.g., textbox versus button) based on its shape and appearance, and therefore, derives the possible input methods on it (e.g., you can type into a textbox and you can click on a button). The strength of the AI processing component is, that it does not simply try to match the image of a control element with a previously taken screenshot of a similar image. Instead, the AI processing component is trained with a voluminous learning set of controls using supervised learning. This approach makes identification of the control type stable even when there are visual differences between them. Thus, just like a human user is able identify a button as a button, no matter the shape or color, the AI processing algorithm similarly identifies identify the button as a button.

After analysis and identification of the one or more control elements, the computer-implemented method 1200 includes, at 1230, generating, using a computer vision component, test automation recording data by recording of user actions performed on the identified one or more control elements. The user actions correspond to one or more actions performed on the one or more control elements of the image file correspond to filling of mock data by a user in the image file. For example, the user may fill data related to email address, loan amount, loan term, and age in the text fields illustrated in the mock image 700 depicted in FIG. 7. The text fields correspond to the one or more control elements, and the filling of data in these text fields corresponds to one or more user actions, which are recorded by the computer vision enabled recorder of the computing system 500. The recording is triggered when the user clicks on the recording option in the ribbon illustrated in FIG. 8A. The computer vision recorder once initiated, records computer vision activities or CV activities (as discussed earlier). Some CV activities include, but are not limited to, click, type, get text, hover, element exists, refresh scope, highlight, etc. The click in some embodiments identifies an element using CV, optical character recognition (OCR), fuzzy text matching, and multi-anchor, for example, and clicks it. The type identifies an element using the above and types in the element. The get text identifies the location of specific text and scan it using the OCR. The hover identifies an element and hover over it. The element exists checks whether an element exists on the screen using the techniques described above. In some embodiments, there may be hundreds or even thousands of activities that may be implemented in the designer 310. However, any number and/or type of activities may be available without deviating from the scope of the invention. The UI automation activities 330 are a subset of special, lower level activities that are written in lower level code (e.g., CV activities) and facilitate interactions with the screen, such as one or more user actions performed on the one or more control elements of the mock image file.

Based on the recording of these one or more user actions, the test automation recording data is generated and is used, at 1240, for generating a test automation file for the application under test. For example, when the user stops the recording, the recorded automations are shown in the computing system, such as UiPath Studio Pro in sequential form as a workflow, as illustrated in FIG. 9A.

These recorded automations can then be used for testing of a live application, such as an application corresponding to the application under test, once the live application is developed. In some embodiments, the generated test automation file corresponds to an RPA test automation in which the various recorded automations are stored in the form of a sequential workflow. In some embodiments, the recorded test automations in the test automation file are later associated with the live application by specifying a correct target, such as a browser like Chrome, and then used for running the recorded automations on the live application for testing of the live application.

The process steps performed in FIG. 12 are performed by a computer program, encoding instructions for the processor(s) to perform at least part of the process(es) described in FIG. 12, according to embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 520 of computing system 500 of FIG. 5) to implement all or part of the process steps described in FIG. 12, which may also be stored on the computer-readable medium.

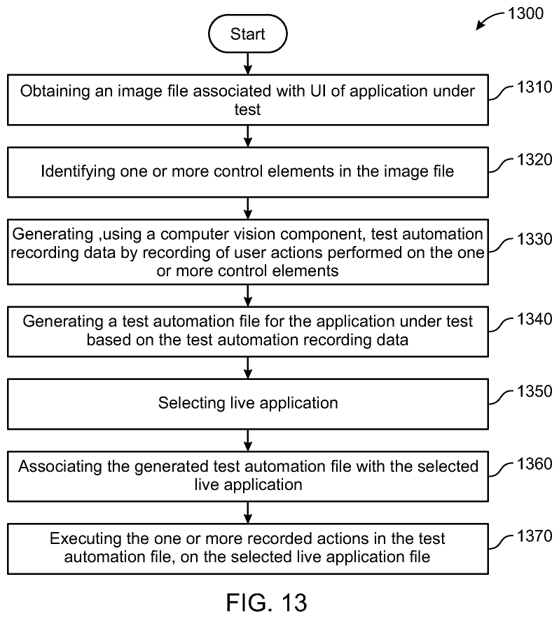

FIG. 13 is a flowchart illustrating a computer-implemented method 1300 for testing a live application, according to an embodiment of the present invention.

The computer-implemented method 1300 includes all of the processing steps described previously in conjunction with the computer-implemented method 1200. For example, the computer-implemented method 1300 begins control at Start, and includes, at 1310, obtaining the image file associated with a user interface design of the application under test, and at 1320, identifying one or control elements in the image file. The identification is done using the artificial intelligent component, such as the AI-enabled cloud sever to which the image file can be uploaded for analysis and identification of the one or more control elements. Then, at 1330, the test automation recording data is generated using a computer vision component for recording one or more user actions performed on the one or more control elements, as described earlier.

Further, at 1340, the test automation file including the test automation recording data is generated for the application under test.

For real testing to take place using the recorded test automation, at 1350, a live application is selected. The live application could be opened in a browser (such as Chrome), and is selected using the process illustrated in FIGS. 11A and 11B. For example, on the recorded test automation, the user clicks on Edit Selector option for selecting the live application file open in the browser in a separate window on the computing system 500.

Further, at 1360, the generated test automation file is associated with the selected live application, as illustrated in FIG. 11C. For this, we specify the target at the browser, such as the Chrome, in the Selector Editor of the recorded test automation. Once the association between the live application and the recorded test automation is established, at 1370, the one or more recorded user actions in the test automation file are executed on the live application, such as when the user clicks a run file option provided in the computing system, such as by the Studio module of the computing system 500. Thereafter, the computing system 500 communicates with AI enabled cloud server to analyze the live application and then performs automation.

In some embodiments, the user can add computer vision activities in their workflow for test automation and indicate the scope by selecting a button on an image that is uniquely identifiable as shown in FIG. 9B.

In this way, the computer-implemented methods 1200 and 1300 enable to truly shift left the test automation efforts by enabling the user to start automating user interfaces without really having access to the actual user interface.

The process steps performed in FIG. 13 are performed by a computer program, encoding instructions for the processor(s) to perform at least part of the process(es) described in FIG. 13, according to embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 520 of computing system 500 of FIG. 5) to implement all or part of the process steps described in FIG. 13, which may also be stored on the computer-readable medium

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present disclosure, as generally described and illustrated in the figures herein, may be arranged and designed in a wide variety of different configurations. Thus, the detailed description of the embodiments of the present disclosure, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present disclosure. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present disclosure should be or are in any single embodiment of the invention. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for generating a test automation file for an application under test, comprising:
obtaining, by at least one processor, an image file associated with a user interface design of the application under test, the image file being a mockup image of a user interface prepared during a design stage of a software development lifecycle;
identifying, by the at least one processor, one or more control elements in the image file associated with the user interface design of the application under test, wherein the one or more control elements comprise of one or more fields accessible by the user for input of data;
generating, by the at least one processor, test automation recording data using a computer vision component, wherein the generating of the test automation recording data comprises recording one or more actions performed on the one or more control elements of the obtained image file; and
generating, by the at least one processor, the test automation file for the application under test based on the test automation recording data, wherein the test automation file comprises the generated test automation recording data without providing access to an actual user interface of the application under test.

2. The computer-implemented of claim 1, further comprising:
obtaining, by the at least one processor, the generated test automation file;
selecting, by the at least one processor, a live application file;
associating, by the at least one processor, the generated test automation file with the selected live application file; and
executing, by the at least one processor, the one or more recorded actions associated with the generated test automation recording data, on the selected live application file based on the association.

3. The computer-implemented of claim 1, wherein the recording of the one or more actions is in a sequential form of a workflow.

4. The computer-implemented of claim 1, wherein to record the one or more actions, the method further comprises:
receiving, by the at least one processor, computer vision activities of the user in a workflow; and
receiving, by the at least one processor, selection, by the user, of a button on the image file that is uniquely identifiable.

5. The computer-implemented of claim 1, wherein the identifying of the one or more control elements in the image file associated with the user interface design of the application under test further comprises:
uploading, by the at least one processor, on a cloud server, the obtained image file associated with the user interface design of the application under test, wherein the cloud server comprises the processing component;
processing, by at least one processor associated with the cloud server, the uploaded image file, wherein the processing of the uploaded image comprises identifying a position for each of the one or more control elements by using a coordinate system on the obtained image file; and
identifying, by the at least one processor associated with the cloud server, the one or more control elements in the image file based on the processing.

6. The computer-implemented of claim 5, wherein the identifying of the one or more control elements comprises identifying, by the at least one processor associated with the cloud server, a control type for each of the one or more control elements based on one or more features of the image.

7. The computer-implemented of claim 1, wherein the one or more actions performed on the one or more control elements of the image file correspond to filling of mock data by a user in the image file.

8. The computer-implemented of claim 1, wherein the generated test automation file is a robotic process automation (RPA) workflow file.

9. A non-transitory computer-readable medium storing a computer program, the computer program configured to cause at least one processor to:
obtain an image file associated with a user interface design of the application under test, the image file being a mockup image of a user interface prepared during a design stage of a software development lifecycle;
identify one or more control elements in the image file associated with the user interface design of the application under test, wherein the one or more control elements comprise of one or more fields accessible by the user for input of data;
generate test automation recording data using a computer vision component, wherein the generating of the test automation recording data includes recording one or more actions performed on the one or more control elements of the obtained image file; and
generate the test automation file for the application under test based on the test automation recording data, wherein the test automation file comprises the generated test automation recording data without providing access to an actual user interface of the application under test.

10. The non-transitory computer-readable medium of claim 9, the computer program is further configured to cause the at least one processor to:
obtain the generated test automation file;
select a live application file;
associate the generated test automation file with the selected live application file; and
execute the one or more recorded actions associated with the generated test automation recording data on the selected live application file based on the association.

11. The non-transitory computer-readable medium of claim 9, wherein the recording of the one or more actions is in a sequential form of a workflow.

12. The non-transitory computer-readable medium of claim 9, wherein the computer program is further configured to cause the at least one processor to:
receive computer vision activities of the user in a workflow; and
receive selection, by the user, of a button on the image file that is uniquely identifiable.

13. The non-transitory computer-readable medium of claim 12, wherein the computer program is further configured to cause the at least one processor to
upload on a cloud server the obtained image file associated with the user interface design of the application under test, wherein the cloud server comprises the processing component;
process the uploaded image file; and
identify the one or more control elements in the image file based on the processing.

14. The non-transitory computer-readable medium of claim 13, wherein the computer program is further configured to cause the at least one processor to identify a position for each of the one or more control elements by using a coordinate system on the obtained image file.

15. The non-transitory computer-readable medium of claim 14, wherein the computer program is further configured to cause the at least one processor to identify a control type for each of the one or more control elements based on one or more features of the image.

16. The non-transitory computer-readable medium claim 9, wherein the one or more actions performed on the one or more control elements of the image file correspond to filling of mock data by a user in the image file.

17. The non-transitory computer-readable medium of claim 9, wherein the generated test automation file is a robotic process automation (RPA) workflow file.

18. A computing system, comprising:
memory storing machine-readable computer program instructions; and
at least one processor configured to execute the computer program instructions, the computer program instructions are configured to cause the at least one processor to:
obtain an image file associated with a user interface design of the application under test, the image file being a mockup image of a user interface prepared during a design stage of a software development lifecycle;
identify, by an artificial intelligence processing component, one or more control elements in the image file associated with the user interface design of the application under test;
generate test automation recording data, using a computer vision component, by recording one or more actions performed on the one or more control elements of the image file, wherein the generated test automation recording data comprises one or more recorded actions associated with each of the one or more actions performed on the one or more control elements of the image file; and
generate the test automation file for the application under test based on the generated test automation recording data, wherein the test automation file comprises the generated test automation recording data.

19. The system of claim 18, wherein the recording of the one or more actions is in a sequential form of a workflow.

20. The system of claim 18, wherein the computer program instructions are further configured to cause the at least one processor to:
obtain the generated test automation file;
select a live application file;
associate the generated test automation file with the selected live application file; and
execute the one or more recorded actions associated with the generated test automation recording data on the selected live application file based on the association.
